(19) United States
(12) Patent Application Publication
(10) Pub. No.: US 2024/0067397 A1
(43) Pub. Date: Feb. 29, 2024

(54) Stackable Storage Container

(71) Applicant: Kyle Zimmerman, Truckee, CA (US)

(72) Inventor: Kyle Zimmerman, Truckee, CA (US)

(21) Appl. No.: 18/455,383

(22) Filed: Aug. 24, 2023

Related U.S. Application Data
(60) Provisional application No. 63/400,517, filed on Aug. 24, 2022.

(51) Int. Cl. B65D 21/02; B65D 1/22; B65D 25/02; B65D 25/20; B65D 43/02; B65D 51/24; B65D 53/02; B65D 65/38; B65D 81/20

(52) U.S. Cl. CPC B65D 21/0219; B65D 1/22; B65D 25/02; B65D 25/20; B65D 43/0204; B65D 43/0214; B65D 51/24; B65D 53/02; B65D 65/38; B65D 81/2038; B65D 2543/00194; B65D 2543/00972; G01L 19/08

(57) ABSTRACT

A stackable storage container that includes multiple quick connect fittings for flushing the container atmosphere and maintaining a vacuum within the closed stackable storage container, as well as pressure, temperature, and relative humidity sensors and displays for monitoring the interior volume of the container. The base includes a honeycomb structure that includes vertical perimeter edges intersecting at perpendicular angles to form a grid of squares. The base also includes vertically oriented support posts and bracing contact points positioned above each of the support posts.

### CROSS-REFERENCE TO RELATED APPLICATIONS

This application claims the benefit of U.S. Provisional Application No. 63/400,517, filed on Aug. 24, 2022. The above identified patent application is herein incorporated by reference in its entirety to provide continuity of disclosure.

### BACKGROUND OF THE INVENTION

The present invention relates to a stackable storage container. More particularly, the present invention provides a stackable storage container that includes multiple quick connect fittings for flushing the container atmosphere and maintaining a vacuum within the closed container, as well as pressure, temperature, and relative humidity sensors and displays for monitoring the interior volume of the container.

Many items including foodstuffs, plant matter, and other biodegradable substances must be carefully stored to be properly preserved over time. Containers exist that are specifically designed for this task. Such containers may include an airtight lid and may further include valves for flushing the atmosphere of the container with nitrogen or other gases, or for removing air entirely via a vacuum pump, thus preserving the container's contents. However, these containers lack features that would benefit individuals seeking to store such materials. For example, most containers in the known art are not structurally stable under a vacuum to the point where they may be easily stacked for efficient storage. Further, many containers do not include any monitoring capabilities. An individual is unable to determine whether the interior of the container is maintaining a proper vacuum seal, or whether the temperature, humidity, or other environmental factors within the container are within a desired range. Without this capability, the items within the container are more likely to suffer damage or improper storage conditions.

In light of the devices disclosed in the known art, it is submitted that the present invention substantially diverges in functional and design elements from the known art and consequently it is clear that there is a need in the art for an improvement to existing stackable storage containers. In this regard the present invention substantially fulfills these needs.

### SUMMARY OF THE INVENTION

In view of the foregoing disadvantages inherent in the types of stackable storage containers and similar devices now present in the known art, the present invention provides a stackable storage container that may achieve a vacuum seal, whereby an individual may monitor the pressure, temperature, relative humidity, and other qualities of the interior of the container.

The present system comprises a stackable storage container that includes a base, a pair of sidewalls, a pair of end walls, and an upper opening defining an interior volume. The lower exterior side of the base includes a honeycomb structure that provides structural support to the container, particularly when a vacuum is applied to the interior volume. The exteriors of the sidewalls include vertical ridges that serve a similar purpose. A lid is removably securable over the open upper end, wherein the lid is configured to maintain an airtight seal. The upper side of the lid includes projections that define an area upon which another container may easily and securely stack. The end walls include quick connecting fittings that allow for different types of air hose connections for flushing the interior atmosphere and for achieving a vacuum within the sealed container.

The interior-facing ends of the quick connect fittings include filters to prevent particles from the air hoses from entering the interior volume. One end wall includes a pressure gauge that is configured to monitor and display the current atmospheric pressure within the container. The interior volume includes a compartment that is configured to removably receive a sensor display. The sensor display may be configured to measure and display the current relative humidity and temperature within the interior volume. The container is transparent to allow an individual to view the container contents and the sensor display while it is secured within the container. In this way, the individual may easily monitor the container conditions and ensure that they remain correct for the type of stored material.

The sensor display includes a plurality of Bluetooth monitoring sensors. More specifically, the Bluetooth monitoring sensors include a plurality of Bluetooth hydrometer/temperature sensors.

One object of the present invention is to provide a stackable storage container that includes specific materials and construction such that it is deemed a food grade storage container.

Another object of the present invention is to provide a stackable storage container that includes multiple structural features that allow the container to remain stable and maintain its shape when a vacuum is applied to its interior volume.

Other objects, features, and advantages of the present invention will become apparent from the following description taken in conjunction with the accompanying figures.

### BRIEF DESCRIPTION OF THE DRAWINGS

The invention itself and manner in which it may be made and used may be better understood after a review of the following description, taken in connection with the accompanying figures. Figures that include or show specific dimensions or other measurements do so for example purposes only and are not intended to limit the scope of the present invention.

FIG. 1 shows a front perspective view of an embodiment of the stackable storage container.

FIG. 2A shows a top plan view of an embodiment of the stackable storage container.

FIG. 2B shows a side perspective view of an alternate embodiment of a cylinder-shaped base of the stackable storage container.

FIG. 2C shows an overhead perspective view of an alternate embodiment of a cap for a cylinder-shaped base.

FIG. 3 shows a bottom plan view of an embodiment of the stackable storage container.

FIG. 4 shows a front elevation view of an embodiment of the stackable storage container.

FIG. 5 shows a rear elevation view of an embodiment of the stackable storage container.

FIG. 6 shows a side elevation view of an embodiment of the stackable storage container.

FIG. 7 shows an interior bottom perspective view of an embodiment of the stackable storage container detailing certain lid reinforcement members.

FIG. 8 shows a front perspective view of an alternate embodiment of the stackable storage container with the lid closed.

FIG. 9 shows an overhead perspective view of an alternate embodiment of the stackable storage container with the lid opened.

### DETAILED DESCRIPTION OF THE INVENTION

Reference is made herein to the attached figures. For the purposes of presenting a brief and clear description of the present invention, the preferred embodiment will be discussed as used for providing a stackable storage container with vacuum sealing capabilities and various monitoring capabilities. The figures are intended for representative purposes only and should not be considered to be limiting in any respect.

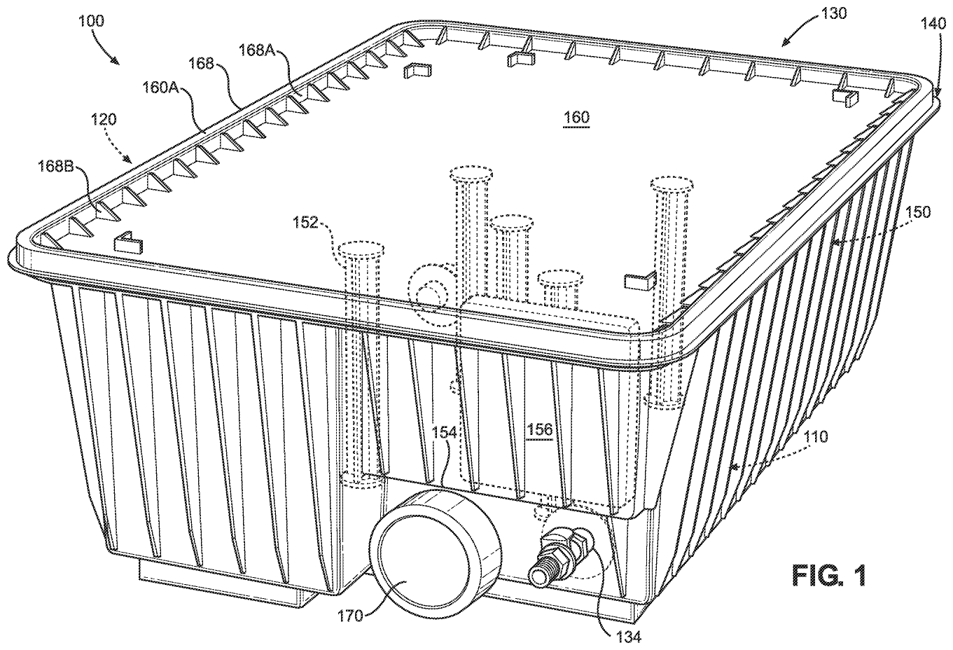

FIG. 1 shows a front perspective view of an embodiment of the stackable storage container 100.

The stackable storage container 100 may include a base 110, a pair of sidewalls 120, a pair of end walls 130, an upper opening 140, an interior volume 150, and a lid 160.

The lid 160 may be removably securable over the upper opening 140 of the stackable storage container 100, wherein the lid 160 may be configured to maintain an airtight seal. The lid 160 may include a snap fit connection 162 or a friction fit connection 164 and may include a silicone gasket 166 or the like to enhance the seal between the lid 160 and an upper perimeter edge 169 of the stackable storage container 100.

The lid 160 may include an upper side 160A of the lid 160 that may include a plurality of projections 168 that define an area 168A upon which another stackable storage container 100 may easily stack. In the shown embodiment, the projections 168 may be a plurality of L-shaped corner guides 168B, but other projections or retaining wall shapes may be utilized to help stabilize the stackable storage container 100.

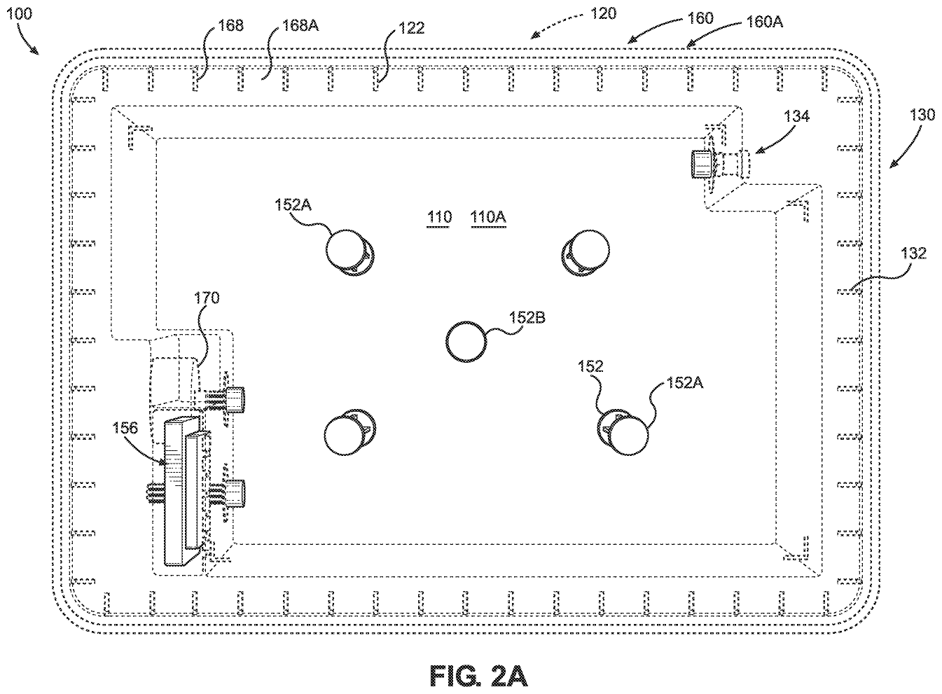

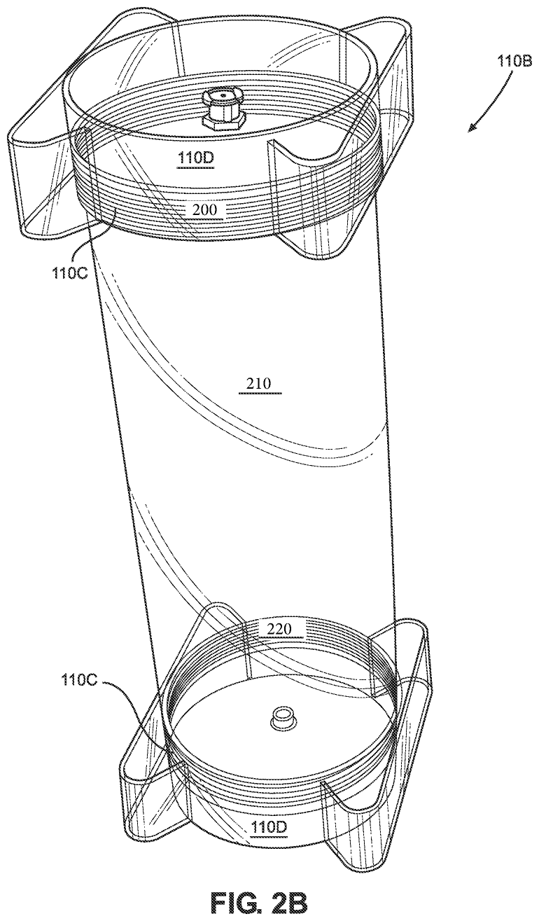

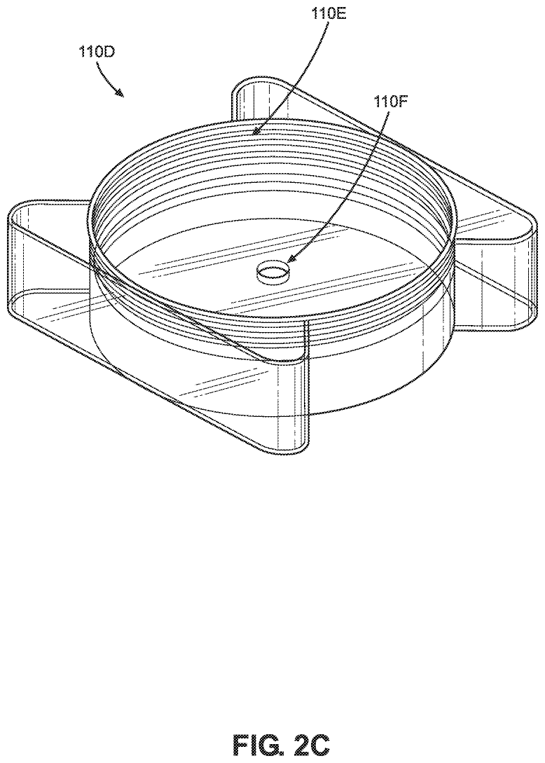

FIG. 2A shows a top plan view of an embodiment of the stackable storage container 100.

FIG. 2A also shows the lid 160 may include an upper side 160A of the lid 160 that may include a plurality of projections 168 that define an area 168A upon which another stackable storage container 100 may easily stack.

The base 110 may have a generally rectangular shape 110A, but other shapes and sizes may be utilized.

FIG. 2B shows a side perspective view of an alternate embodiment of a cylinder-shaped base 110B.

The cylinder-shaped base 110B may include a first end 200, a tubular body 210 and a second end 220

The first end 200 and the second end 220 may each have a first plurality of threading 110C to receive a cap (FIG. 2C, 110D) to seal the first end 200 and the second end 220 of a cylinder-shaped base 110B.

FIG. 2C shows a perspective view of an alternate embodiment of a cap 110D for a cylinder-shaped base 110B.

The cap 110D may also include a second plurality of threading 110E and a centered aperture 110F disposed inside of the cap 110D.

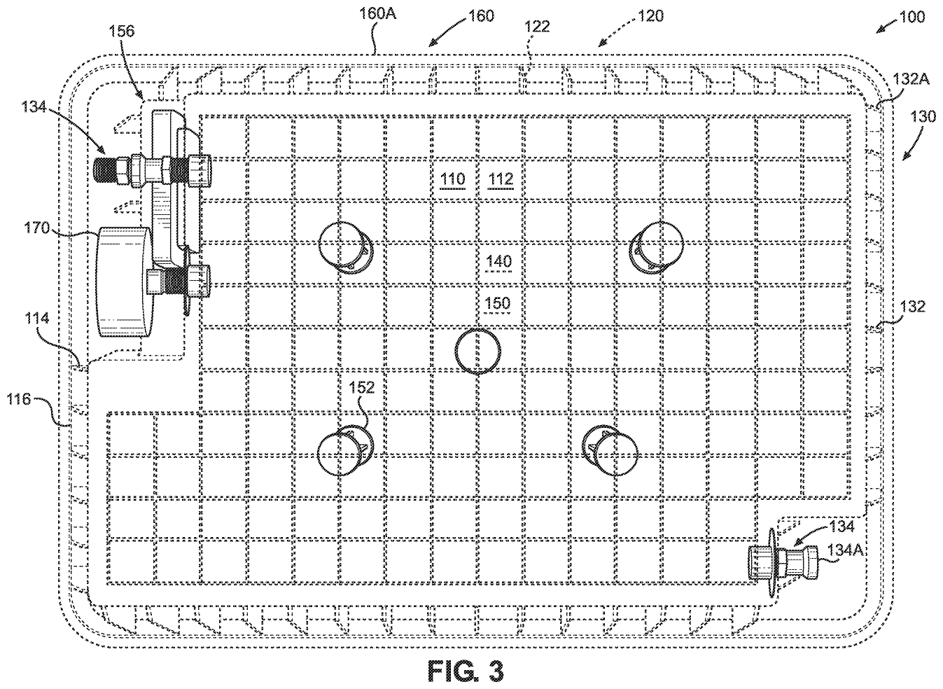

FIG. 3 shows a bottom plan view of an embodiment of the stackable storage container 100.

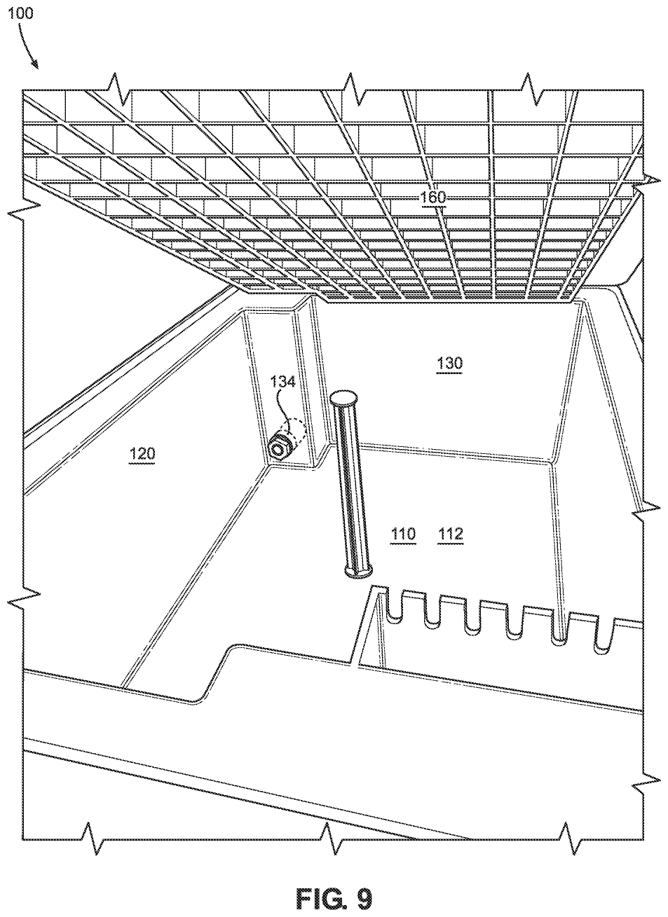

The base 110 may include a honeycomb structure 112 that provides structural support to the stackable storage container 100. The honeycomb structure 112, most clearly visible in FIGS. 3 and 9, defines a plurality of vertical perimeter edges 114 extending downwardly from the lower exterior side of the base 110. The vertical perimeter edges 114 may intersect at perpendicular angles to form a grid of squares 116. In other embodiments, the honeycomb structure 112 may include different patterns such as semicircles, ovals, or the like.

The pair of sidewalls 120 may extend perpendicularly from each side of the base 110. The pair of sidewalls 120 may include a first plurality of exterior, vertical, fins or ridges 122 that serve a similar purpose to the honeycomb structure 112.

The pair of end walls 130 may extend perpendicularly from each end of the base 110. The pair of end walls 130 may include a second plurality of exterior, vertical, fins or ridges 132 that serve a similar purpose to the honeycomb structure 112. Further, a plurality of upper edges 132A of the exterior, vertical, fins or ridges 132 may provide additional lateral rigidity.

The upper opening 140 may be formed from the pair of sidewalls 120 and the pair of end walls 130 extending from the base 110.

The interior volume 150 may define the upper opening 140.

When another stackable storage container 100 is placed on the lid 160, the exterior perimeter of the honeycomb structure 112 loosely contacts the interior surfaces of the projections 168. This may help maintain the stackable storage container 100 in a stacked configuration and prevents an upper stackable storage container 100 in the stack from accidentally sliding off of its lower supporting stackable storage container lid 160.

Further, as shown in FIG. 1, the lid 160 may include additional perimeter supporting fins 165 that extend between a raised perimeter lip 165A and the upper side 160A of the lid 160, which provide additional structural integrity to help the lid 160 remain flat and sturdy, particularly when a vacuum is applied to the interior volume 150 of the stackable storage container 100.

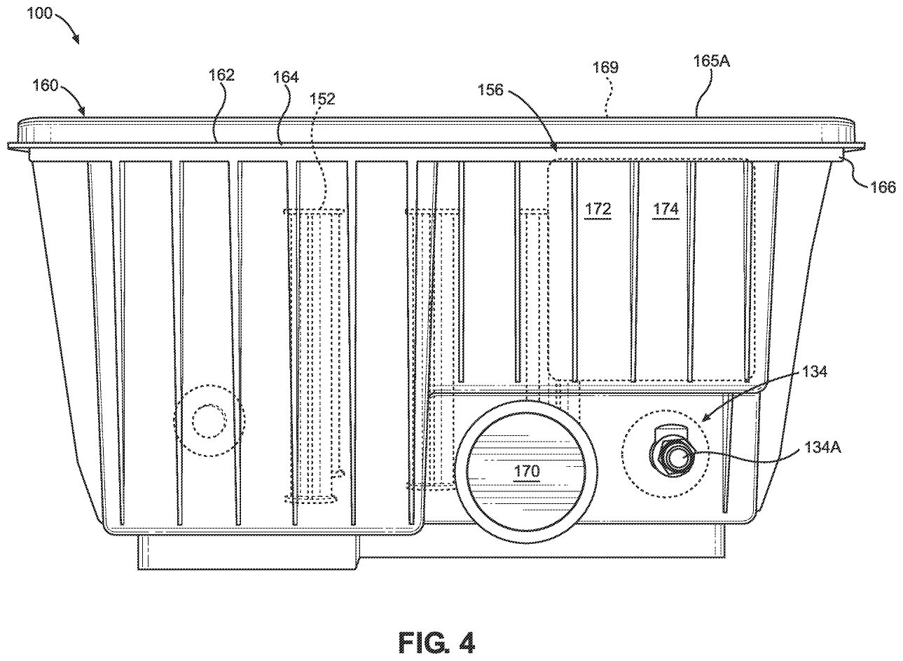

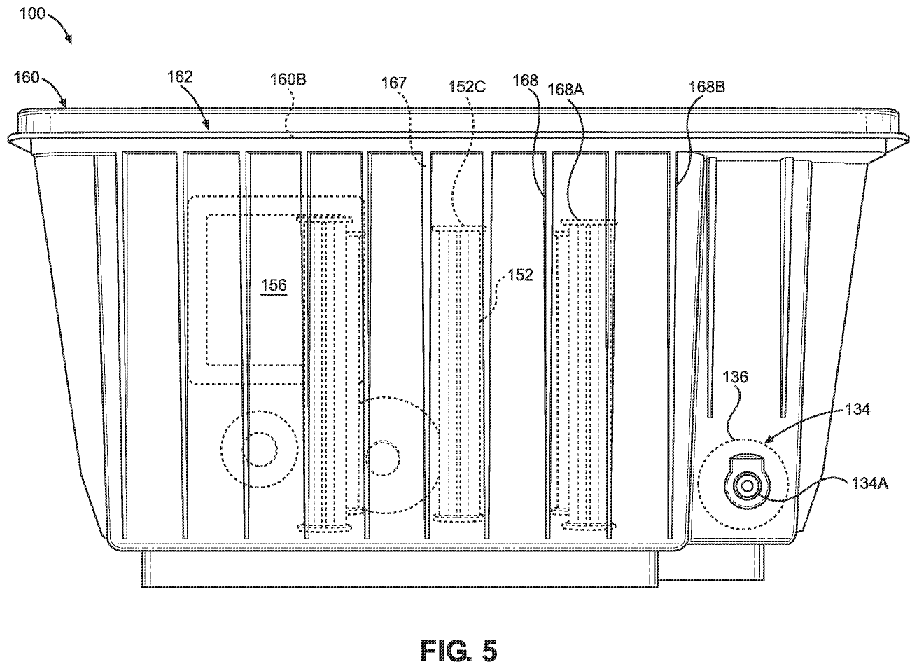

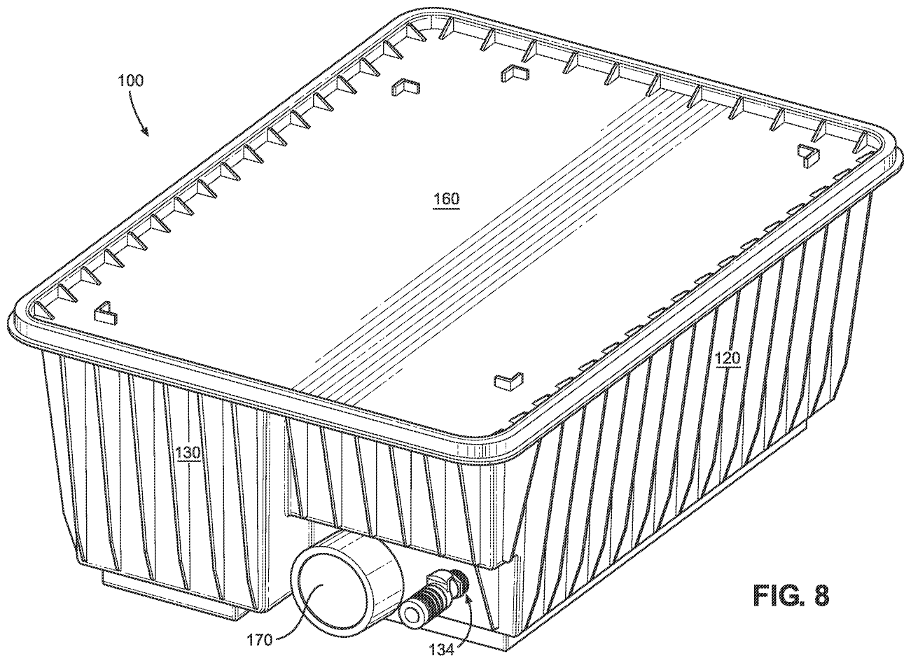

In the shown embodiment, the interior volume 150 of the stackable storage container 100 includes a plurality of vertically oriented support posts 152. The shown embodiment in FIGS. 1-7 includes four vertically oriented support posts 152A and a central vertically oriented support post 152B, or the like and other arrangements may be utilized, as shown in FIGS. 8 and 9.

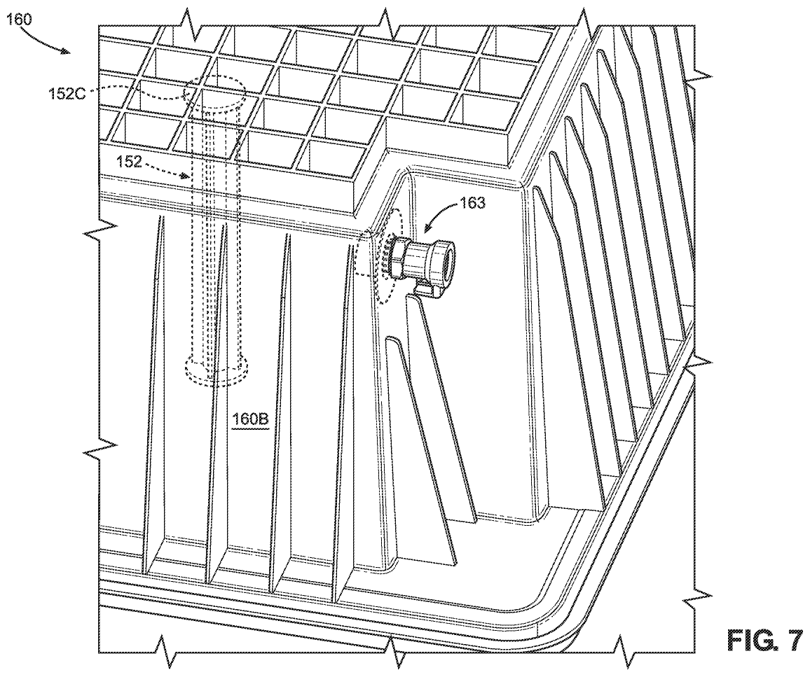

Visible in FIG. 7, a lower side 160B of the lid 160 may include a plurality of bracing contact points 163 positioned above each of the support posts 152. When the lid 160 may be secured to the stackable storage container 100 under regular atmospheric pressure, there is a slight gap 167 between an upper end 152C of the support post 152 and the lower side 160B of the lid 160. When a vacuum is applied to the interior volume 150, negative pressure may cause the lid 160 to compress downward, whereby the support posts 152 may then contact the bracing contact points 163 on the lid 160. In this way, the support posts 152 may provide additional structural integrity to the stackable storage container 100 when air is removed from the interior volume 150, preventing the lid 160 from caving in under the negative pressure.

As shown in FIGS. 1, 4, and 5, the pair of end walls 130 may include a plurality of quick connect fittings 134 that allows for different types of air hose connections. For example, the quick connect fittings 134 may be adapted to removably secure a nitrogen hose, another flushing-type air hose, or a vacuum hose (all not shown), for example.

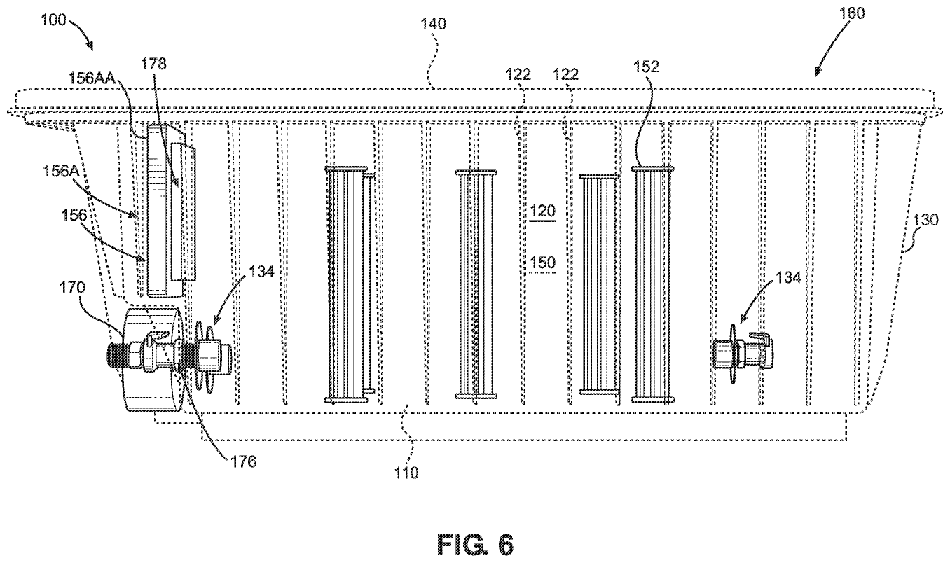

In one embodiment, as most clearly shown in FIGS. 3 and 6, an interior-face end 134A of each of the quick connect fittings 134 may include a fine mesh filter 136 to prevent particles from the air hoses from entering the interior volume 150. The fine mesh filter 136 may be preferably composed of food grade stainless steel, but other materials may be utilized. The quick connect fittings 134 may be used simultaneously if desired, for example if an individual wishes to flush a lid-sealed stackable storage container 100 with nitrogen while simultaneously pulling the nitrogen and other air out via another quick connect fitting 134 to achieve a vacuum within the interior volume 150. In other embodiments, other gases besides nitrogen may be introduced into and/or removed from the interior volume 150.

As shown in FIGS. 1, 4, and 8, one end wall 130 includes a vacuum gauge 170 that is configured to monitor and display the current air pressure within a closed stackable storage container 100. The vacuum gauge 170 may removably secure to an additional quick connect fitting 134 or may be permanently secured to the stackable storage container 100. The vacuum gauge 170 may include an analog readout 172 or a digital readout 174 for determining the current pressure within the stackable storage container 100. In this way, an individual may easily monitor the vacuum gauge 170 to ensure that a vacuum has been achieved.

The interior volume 150 may include a compartment 154 that is configured to removably receive a sensor display 156, which may be most clearly seen in FIGS. 1 and 9. The sensor display 156 may be configured to measure and display the current temperature and relative humidity within the interior volume 150. In some embodiments, the sensor display 156 may measure other parameters of the interior volume 150. The stackable storage container 100 may be transparent to allow an individual to view the sensor display 156 while it is secured within its compartment 154 in the stackable storage container 100, allowing the individual to monitor the stackable storage container 100 conditions and ensure that they remain correct for the type of stored material. The sensor display 156 may also be removable, such that it may be moved between stackable storage containers 100 or otherwise handled.

FIG. 6 shows a side elevation view of an embodiment of the stackable storage container 100.

The sensor display 156 may include a plurality of Bluetooth monitoring sensors 156A. More specifically the Bluetooth monitoring sensors 156A may be a plurality of Bluetooth hydrometer/temperature sensors 156AA which may eliminate the need for the stackable storage container 100 to be transparent and could be any color. The stackable storage container 100 may be controlled via the Bluetooth monitoring sensors 156A or the like as an additional embodiment.

The sensor display 156 may include a plurality of electronic timers 176 and a plurality of solenoid valves 178 that are able to open and close approximately 100 or more stackable storage containers 100 at once remotely, as an alternate embodiment.

Preferably, the components of the stackable storage containers 100 may be composed of materials that are “food grade” or “food safe”. For example, the metallic components such as the fine mesh filter 136 may be made of stainless steel, or a non-corroding food grade material. The pair of sidewalls 120, the pair of end walls 130, the base 110, and the lid 160 may also be made of transparent food grade materials. However, other embodiments may include different types of materials.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A stackable storage container, comprising:
a base having a honeycomb structure;
a pair of sidewalls extending perpendicularly from each side of the base;
a pair of end walls extending perpendicularly from each end of the base;
an upper opening formed from the pair of sidewalls and the pair of end walls extending from the base producing an interior volume;
an interior volume defined from the upper opening;
a lid removably secured over the upper opening to maintain an airtight seal; and
a vacuum gauge configured to monitor and display current air pressure within a closed stackable storage container.

2. The stackable storage container, according to claim 1, wherein the base is rectangular-shaped or cylindrical-shaped.

3. The stackable storage container, according to claim 1, wherein the honeycomb structure includes a plurality of vertical perimeter edges extending downwardly from a lower exterior side of the base.

4. The stackable storage container, according to claim 3, wherein the honeycomb structure includes the vertical perimeter edges each intersecting at a perpendicular angle to form a grid of squares.

5. The stackable storage container, according to claim 1, wherein the pair of sidewalls and the pair of end walls each include a plurality of exterior, vertical, fins or ridges.

6. The stackable storage container, according to claim 1, wherein the pair of end walls includes a plurality of quick connect fittings that allows for different types of air hose connections.

7. The stackable storage container, according to claim 6, further comprising an interior-face end of each of the quick connect fittings include a fine mesh filter to prevent particles from one or more air hoses from entering the interior volume.

8. The stackable storage container, according to claim 7, wherein the fine mesh filter is composed of food grade stainless steel.

9. The stackable storage container, according to claim 1, wherein the interior volume includes a plurality of vertically oriented support posts.

10. The stackable storage container, according to claim 9, herein the lid includes a plurality of bracing contact points positioned above each of the vertically oriented support posts.

11. The stackable storage container, according to claim 1, wherein the interior volume includes a compartment that is configured to removably receive a sensor display configured to measure and display current temperature and relative humidity within the interior volume.

12. The stackable storage container, according to claim 11, wherein the stackable storage container is transparent to allow an individual to view the sensor display while it is secured within its compartment in the stackable storage container, allowing the individual to monitor a plurality of stackable storage container conditions and ensure that they remain correct for a type of stored material.

13. The stackable storage container, according to claim 11, wherein the sensor display includes a plurality of Bluetooth monitoring sensors.

14. The stackable storage container, according to claim 13, wherein the Bluetooth monitoring sensors include a plurality of Bluetooth hydrometer/temperature sensors.

15. The stackable storage container, according to claim 1, wherein the lid includes a snap fit connection or a friction fit connection.

16. The stackable storage container, according to claim 1, wherein the lid includes a silicone gasket to enhance the seal between the lid and an upper perimeter edge of the stackable storage container.

17. The stackable storage container, according to claim 1, wherein the lid includes an upper side of the lid that includes a plurality of projections that define an area upon which another stackable storage container stacks.

18. The stackable storage container, according to claim 17, wherein the projections are a plurality of L-shaped corner guides.

19. The stackable storage container, according to claim 1, wherein the vacuum gauge includes an analog readout for determining current pressure within the stackable storage container or a digital readout for determining current pressure within the stackable storage container.

20. The stackable storage container, according to claim 1, wherein the stackable storage containers are composed of food grade material.
